(19) United States
(12) Patent Application Publication
(10) Pub. No.: US 2015/0121676 A1
(43) Pub. Date: May 7, 2015

(54) Supporting collar for articles such as cables, pipes or the like

(71) Applicant: FI.MO.TEC. S.P.A., Cologno Monzese-Milano (IT)

(72) Inventors: Carlo Feige, Cologno Monzese - Milano (IT); Alberto Varale, Cologno Monzese - Milano (IT); Massimo Bottazzoli, Cologno Monzese - Milano (IT)

(73) Assignee: FI.MO.TEC. S.P.A., Cologno Monzese - Milano (IT)

(21) Appl. No.: 14/394,258

(22) PCT Filed: Apr. 24, 2013
(86) PCT No.: PCT/EP2013/001254

§ 371 Date: Oct. 13, 2014

(30) Foreign Application Priority Data
Apr. 27, 2012 (IT) MI2012A000709

(51) Int. Cl. F16L 3/13

(52) U.S. Cl. CPC F16L 3/13
USPC 29/428; 248/614

(57) ABSTRACT

A supporting collar for elongated articles, in particular, cables or pipes, includes holding members of the elastic type having two opposite ends, optionally metallic, outwardly extendable to allow the introduction of the article between the ends in a direction transversal to its own longitudinal axis; connection members suitable for fixing the collar to a fixed structure and/or to another collar; and a substantially tubular gasket made of a flexible or elastomeric plastic material, in particular EPDM rubber (ethylene-propylene-diene monomer), fixed to the holding members, suitable for receiving in its interior a section of the article and having a longitudinal opening situated between the ends, the opening having, in correspondence with the outer edges, a flared portion broadening outwards. A fixing method of an article using such collar.

### FIELD OF THE INVENTION

The present invention relates to a fixing collar of tubular articles, such as pipes, cable or the like. More specifically, it relates to a collar suitable for fixing cables with an outer coating made of PVC, PE, rubber or similar materials, for example cables for transporting energy or optical fibers or for telecommunications. The collar is suitable for fixing to a fixed support and, according to a particular aspect of the invention, can be modular, i.e. suitable for being fixed to identical or similar collars.

### BACKGROUND OF THE INVENTION

Various types of collars for fixing cables, pipes or similar articles, are known in the field of construction, telecommunications and energy distribution. In particular, collars are known which are elastically fitted onto the article to be fixed and have connection systems for fixing to fixed structures and also, in the case of modular collars, to other collars of the same type and dimensions, or also different dimensions.

The collar is generally metallic and has portions which can be elastically expanded to receive the article to be fixed and, thanks to its elastic force, to hold it, once released. The holding of the article, in particular in the direction of the longitudinal axis of the article itself, is achieved by the friction force of said portions on the outer surface of the article. An example of similar collars is described in international patent application WO2010/143222.

The friction coefficient between the metal and material forming the sheath is not always sufficient for guaranteeing an adequate retaining force, also considering the fact that the same dimension of the collar can generally be used for a series of diameters of the pipe or cable; consequently, it is common practice, in the case of collars of this type, to create notches in the elements in contact with the article to be held, in correspondence with the edges, so that, by folding a small portion between two adjoining notches, on the side destined for receiving the article to be held, a holding flap can be created, which opposes the longitudinal sliding. This system is effective and adequate when the article has a sheath or resistant outer surface or there are no insulating problems, as in the case of telecommunication cables or certain types of pipes. Particularly in the case of delicate articles, however, which require guaranteed protection and insulation and in which the outer sheath is made of a more flexible, softer and finer material, and therefore less shear-resistant, as in case of cables for transporting energy or optical fiber cables or telecommunication cables, the flap can cut the material, possibly causing breakages which can jeopardize the functionality of the cable. In order to overcome this drawback, the solution of applying a tape, for example made of plastic or elastomeric material, or portions of tubular sleeve of the same materials, longitudinally open around the article before applying the collar, is often adopted. These materials are not specifically produced for this purpose and must therefore be found separately, before the fixing operations. Furthermore, the application must be effected on the spot, thus complicating the fixing operation of the cable to the collar, which must often be effected under uncomfortable conditions also without this additional difficulty, with a consequent prolonging of time necessary for effecting the work and also greater risks due to the use of both hands also in situations in which it may be necessary to have both hands free for supporting oneself. Finally, the result is considerably subject to errors of the operator and is often not reproducible, favoring the possibility of breakdowns due to insufficient retention of the article to be fixed or to inadequate protection of the outer coating.

The above problems have now been overcome with a supporting collar for elongated articles, in particular pipes and cables, as disclosed hereinafter. Preferred embodiments of the invention will be described with particularity.

### BRIEF DESCRIPTION OF THE DRAWINGS

The present invention will be now illustrated in more detail by the description of a preferred embodiment, provided for purely illustrative and non-limiting purposes with respect to the protection scope of the claims, with the help of the enclosed figures, in which:

FIG. 1 is a schematic representation of a collar according to the present invention, in a perspective view;

FIG. 2 represents a schematic representation of the gasket of the collar of FIG. 1, according to a different perspective;

FIG. 3 is a schematic sectional representation of the collar of FIG. 1 according to a plane perpendicular to the original axis of an elongated article as it would appear after being fixed to the collar.

### DETAILED DESCRIPTION OF EMBODIMENTS OF THE INVENTION

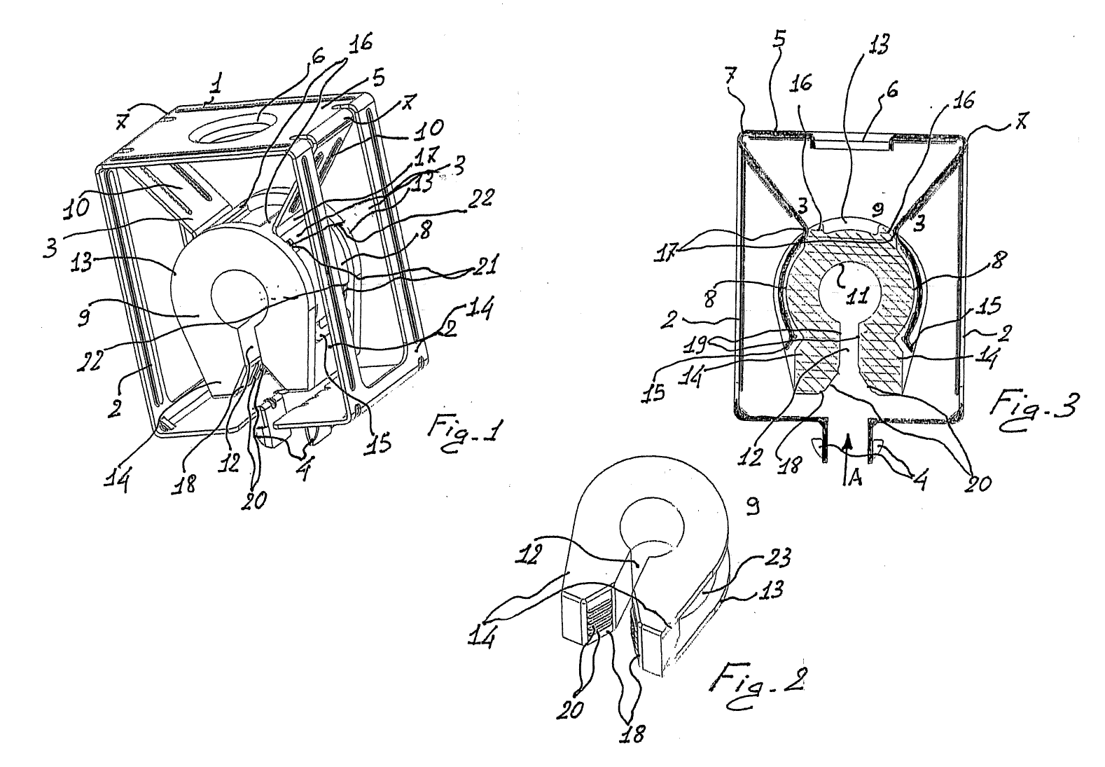

With reference to FIG. 1, a collar according to the present invention comprises a supporting structure 1 which is preferably made of a metallic material or other elastically adequate deformable material, such as plastic material, and a gasket.

The collar comprises elastic holding means, which can be two shaped arms 3, suitable for being extended outwardly by means of an elastic force.

According to a preferred aspect of the invention, the structure can be produced from a metal sheet by shearing and folding or another suitable method.

According to an aspect of the invention, the structure has two side portions 2, that can be elastically moved away from or towards each other and equipped, at one end, with connection means 4 suitable for being connected to a fixed structure. The side portions 2 can depart from a head portion 5, which can be substantially flat and separated from the side portions by folds. According to a particular aspect, the connection means can be situated at the opposite end with respect to the head portion of each of the side portions; they can be envisaged, for example, as teeth facing a reciprocal distancing direction. The side portions 2 can be produced so as to form, in rest position, a certain angle with the head portion and the connection, preferably obtuse and the connection can be effected by moving the side portions 2 towards each other, overcoming the elastic force and introducing the teeth through engagement elements, for example the edges of a suitably-shaped opening, for example a hole having a suitable form or diameter, onto a fixed structure- or on another collar. The release of the side portions 2 can cause their outward extension so as to allow the engagement of the teeth with the edges of the opening or engagement elements and retention of the same thanks to the elastic force. According to a possible aspect, the side portions 2, in a connecting position, can be parallel to each other and perpendicular to the head portion. The head portion can have an opening 6 analogous to what is indicated above, to allow the fixing of a further collar of the same type, making the collar modular. According to a particular aspect of the invention, the holding means 3, which hold the gasket described hereunder, are two arms which can also be elastically extended outwardly, in the same extending or narrowing direction as the side portions, but independently with respect to the same side portions. They can be symmetrical to each other and obtained starting from the side portions by cutting (in particular shearing) and folding. They can be attached to the structure at the end of the side portions opposite to the head portion or, preferably to the same head portion in correspondence with the same edges 7 from where the side portions depart. This solution is more congenial to the presence of the gasket as described hereunder. It should be noted that the supporting structure can be produced, according to a particular embodiment, like the laminar structure of the collar described in patent application WO 2010/143222.

Reinforcing folds and ribs can also be included, according to necessity.

According to a particular aspect of the invention, the arms can have a concave portion 8, having a circumferential arc section, in order to house the gasket 9 and a connecting portion 10 which can, for example, be planar, interposed between the rest of the structure and the concave portion. The arms hold the gasket 9, which is substantially tubular.

With reference to the figures, the gasket has an inner surface 11, preferably cylindrical, which delimits a housing cavity suitable for receiving the article to be fixed and a longitudinal opening 12 suitable for allowing the insertion of the article in the direction of the arrow A of FIG. 3. The insertion can be effected by suitably widening the side portions, if necessary, to allow the passage of the article; the insertion of the article in the longitudinal opening causes the outward extension of the arms. Once the article reaches the housing cavity, the elastic force closes the arms and the gasket, thus holding the article. The gasket, made of a suitable material as mentioned above, thus exerts a friction force on the sheath, whereas its elasticity and deformability avoid damaging the sheath, and consequently the cable, as in the case, for example, of cables for transporting energy or optical fiber cables.

The gasket is suitable for remaining fixed to the supporting structure also in the absence of the article and in the insertion phase of the same. The gasket is suitably held by the holding means.

Its form is preferably such as to prevent its slipping from said holding means, both in the presence and absence of the article. For example, a suitable seat can be envisaged for receiving a portion of said means, in particular the concave portion of the arms.

According to a possible embodiment, means are envisaged for preventing the sliding of the gasket in the direction of the longitudinal axis of the article; they can be represented by terminal flanges 13, which radially exceed the outer dimensions of the gasket in correspondence with the portion in contact with the holding means (see 23 in FIG. 2). Means can be envisaged for retaining the gasket against the thrust exerted by the article when inserted in the direction of the arrow A of FIG. 3. There may, for example, be longitudinal reliefs 14, which can be seen in FIG. 3, that cooperate with the ends 15 of the arms 3. According to a further aspect of the invention, there can be means for preventing the rotation of the gasket with respect to the holding means. There can, for example, be longitudinal reliefs 16, suitable for cooperating with the edge 17 formed by the concave portion 8 of the arms 3 with the connection portion 10. In the embodiment of the figures, the longitudinal reliefs 16, the terminal flanges 13 and longitudinal reliefs 14 delimit the above-mentioned seat in order to receive the concave portion of the arms.

In order to allow the insertion of the gasket, in the production phase of the collar, the ends 15 can be folded or curved outwardly with respect to the concave portion.

The sloping walls 18, which form the flared portion as mentioned above, are present in correspondence with the longitudinal opening 12, and extend towards the outside of the gasket; in this way, the insertion of the article in the direction of the arrow A causes the outward extension of the arms in order to allow the article to be received between them, without having to extend the arms manually, and consequently the operation can be easily effected with one hand only.

The connection surfaces 19 join the sloping walls with the inner surface 11. They can be substantially perpendicular to said surface, or in any case less flared with respect to the sloping walls.

Various kinds of expedients can be includes in order to favor the insertion, such as the series of elongated reliefs 20 on the sloping walls, in a direction lying on the plane perpendicular to the longitudinal axis of the article fixed in the collar, i.e. the insertion direction, so as to reduce the adhesion between the article and gasket in this phase.

The reliefs 14 can be arranged in correspondence with the longitudinal opening, as shown, forming a single thickened section with respect to the other portions of the gasket, on which the same sloping walls are situated.

FIG. 1 shows the notches 21 which create a series of flaps 22, folded inwardly, on the edges of the arms. Said flaps, which, in the known art are used for directly holding the article, are now adopted for improving the fixing of the gasket.

The sizing of the collar and its parts can be easily calculated by an expert in the field, according to requirements. It should be pointed out that it is also possible to act on the thickness of the gasket, so that articles having different diameters can be fixed with collars having the same supporting structure, but with different gaskets.

The invention claimed is:

1.-10. (canceled)

11. A supporting collar for an elongated article, in particular a cable or a pipe, comprising:
a supporting structure (1) made of a flexible material having two side portions (2) that are structured to be elastically moved away from or towards each other and that are delimited, with respect to a head portion (5) of said supporting structure (1), by edges (7), said side portions (2) comprising,
free ends with connecting members (4) configured to connect and secure said supporting collar to a fixed supporting layer or to another collar, and
elastic arms (3) configured to be extended outwardly to allow an insertion therebetween of said elongated article in a direction (A) transverse to a longitudinal axis of said elongated article, and
a substantially tubular gasket (9) attached to said elastic arms (3).

12. The supporting collar according to claim 11, wherein said gasket (9) is made of an elastomeric material and has an inner cavity provided with a longitudinal opening (12) along said direction (A) for inserting said elongated article, said longitudinal opening (12) having, at outer edges thereof, an outwardly broadening flared portion (18).

13. The supporting collar according to claim 12, wherein said elastic arms (3) have a concave portion (8) in contact with said gasket and connecting portions (10) with a rest of said supporting structure, said elastic arms being outwardly extendable substantially independently of the side portions (2).

14. The supporting collar according to claim 13, wherein said connecting portions are planar.

15. The supporting collar according to claim 12, wherein said flared portion comprises a sloping wall (18) on each edge thereof to provide two sloping walls, said sloping walls being disposed to define a V-shaped configuration.

16. The supporting collar according to claim 15, wherein the longitudinal opening (12) has connecting surfaces (19) which join said two sloping walls to an inner surface (11) of the gasket, said inner surface being in contact with the elongated article upon said insertion thereof.

17. The supporting collar according claim 15, wherein said two sloping walls have a series of reliefs (20) configured to favor said insertion of said elongated article.

18. The supporting collar according claim 17, wherein said series of reliefs is a series of elongated reliefs in a direction lying on a plane perpendicular to said longitudinal axis of said elongated article inserted in said supporting collar.

19. The supporting collar according to claim 11, wherein said gasket has members (13) preventing a longitudinal sliding of the gasket.

20. The supporting collar according to claim 19, wherein said members of said gasket are shaped as terminal flanges.

21. The supporting collar according to claims 11, wherein said gasket has holding means (14) for holding said gasket in position against a thrust exerted thereon when said elongated article is inserted therein.

22. The supporting collar according to claim 21, wherein said gasket has preventing means (16) for preventing a rotation of said gasket in relation to said holding means.

23. A method of fixing an elongated article comprising:
providing a collar according to claim 12;
introducing said article into said gasket of said collar through said longitudinal opening in a transversal direction with respect to the longitudinal axis of said elongated article; and
connecting said collar using said connecting members to a fixed structure or to another collar.
